(19) United States
(12) Patent Application Publication
(10) Pub. No.: US 2026/0280374 A1
(43) Pub. Date: Sep. 17, 2026

(54) STATOR FOR ROTATING ELECTRIC MACHINE

(71) Applicant: HONDA MOTOR CO., LTD., Tokyo (JP)

(72) Inventors: Keisuke AZUSAWA, Saitama (JP); Naoya NAITOH, Saitama (JP); Yoshihisa KUBOTA, Saitama (JP)

(21) Appl. No.: 19/555,975

(22) Filed: Mar. 4, 2026

(30) Foreign Application Priority Data
Mar. 13, 2025 (JP) 2025-040090

(51) Int. Cl. H02K 3/28; H02K 21/14

(52) U.S. Cl. CPC H02K 3/28; H02K 21/14

(57) ABSTRACT

A stator for a rotating electric machine according to the present invention includes: a stator core including a plurality of slots, each of which extends in a radial direction, and which are aligned in a circumferential direction; and a coil, which includes a plurality of parallel coils for every phase, and which is wound in the circumferential direction to pass through a plurality of turns in the plurality of slots. The slot includes a first slot in which a first parallel coil is wound in a first turn on an inner diameter side and a second parallel coil is wound in a second turn on the inner diameter side, and a second slot in which the second parallel coil is wound in the first turn on the inner diameter side and the first parallel coil is wound in the second turn on the inner diameter side.

### BACKGROUND

### Technical Field

The present invention relates to a stator for a rotating electric machine used as an electric motor or a generator.

### Related Art

In recent years, research and development on downsizing, weight reduction, yield improvement, and the like that contribute to energy efficiency have been conducted so that more people are able to access affordable, reliable, sustainable, and advanced energy. For example, an electric vehicle (EV) uses only a motor as a power source, and thus has an advantage of not discharging carbon dioxide, nitrogen oxides, or the like during traveling, and is expected as an automobile of a next generation. Therefore, techniques related to improvement in energy efficiency of a motor mounted on an electric vehicle or the like are being developed. Examples of such techniques include a rotating electric machine disclosed in JP 3621635 B2.

### Citation List

### Patent Literature

Patent Literature 1: JP 3621635 B2

### SUMMARY

In recent years, in a charging system for an electric vehicle, when charging an in-vehicle high-voltage battery from an external charging device, an attempt is made to reduce the number of components and cost by using a circuit including windings of a rotating electric machine mounted for driving and generating the electric power, as a part of a charging circuit. In a case where the winding circuit of the rotating electric machine is used as a part of a charger in this manner, if charging is performed by in-phase energization in which the directions of electric currents of the parallel coils in the same phase are aligned, torque will be generated in the rotating electric machine and vibration will occur. For this reason, charging is usually performed by reverse-phase energization in which the directions of the electric currents of the parallel coils are reversed from each other.

The rotating electric machine of Patent Literature 1 described above is not assumed to use a coil of the rotating electric machine when charging a high-voltage battery from an external charging device. Hence, in a case where the coil of the rotating electric machine of Patent Literature 1 is used for charging, there is a problem in that a loss due to an eddy current occurs mainly on the inner diameter side of the stator due to a magnetic flux generated by an electric current at the time of charging, and charging efficiency is lowered.

The present invention has been made to solve the above problem, and has an object to provide a stator for a rotating electric machine capable of reducing an eddy current loss in a case where a coil of the rotating electric machine is used as a part of a charging circuit. In addition, the present invention also contributes to improvement of energy efficiency, accordingly.

In order to achieve the above object, a stator for a rotating electric machine according to a first aspect of the present invention includes: a stator core including a plurality of slots, each of which extends in a radial direction, and which are aligned in a circumferential direction; and a coil, which includes a plurality of parallel coils for every phase, and which is wound in the circumferential direction to pass through a plurality of turns in the plurality of slots. The coil includes a first parallel coil and a second parallel coil that are parallel to each other in at least one phase, the slot includes a first slot in which the first parallel coil is wound in a first turn on an inner diameter side and the second parallel coil is wound in a second turn on the inner diameter side, and a second slot in which the second parallel coil is wound in the first turn on the inner diameter side and the first parallel coil is wound in the second turn on the inner diameter side, and the first slot and the second slot are alternately disposed in the circumferential direction for every pole.

According to this configuration, the coil of the stator includes the first parallel coil and the second parallel coil, which are parallel to each other in at least one phase. In addition, the slot includes the first slot in which the first parallel coil is wound in the first turn on the inner diameter side and the second parallel coil is wound in the second turn on the inner diameter side, and the second slot in which the second parallel coil is wound in the first turn on the inner diameter side and the first parallel coil is wound in the second turn on the inner diameter side. Then, the first slot and the second slot are alternately disposed in the circumferential direction for every pole.

Thus, parallel coils different from each other are wound in the first turn and the second turn of each slot, and in addition, parallel coils different from each other are wound in the same turn of adjacent slots for every pole. In the stator having such a configuration, when the reverse-phase energization in which directions of the electric currents flowing through the first parallel coil and the second parallel coil in one phase are reversed from each other is performed, the magnetic fluxes cancel each other between the first turn and the second turn of the slot, so that an occurrence of the eddy current can be suppressed. Therefore, it becomes possible to reduce the eddy current loss in a case where the stator coil of the rotating electric machine is used for charging.

In the stator for the rotating electric machine according to a second aspect of the present invention, in the stator for the rotating electric machine according to the first aspect of the present invention, in the first slot, one of the first parallel coil and the second parallel coil is wound in a third turn and later on the inner diameter side for every pole, and in the second slot, the other one of the first parallel coil and the second parallel coil is wound in the third turn and later on the inner diameter side for every pole.

According to this configuration, in the first slot, one of the first parallel coil and the second parallel coil is wound in the third turn and later on the inner diameter side for every pole, and in the second slot, the other one of the first parallel coil and the second parallel coil is wound in the third turn and later on the inner diameter side for every pole. As described above, the first slot and the second slot are alternately disposed in the circumferential direction for every pole, and thus in the present configuration, the first parallel coil and the second parallel coil are alternately disposed in the circumferential direction in the third turn and later of each slot for every pole. With such a configuration, when the reverse-phase energization is performed, the magnetic flux generated in the first parallel coil and the magnetic flux generated in the second parallel coil can be prevented from interfering with each other, so that the inductance can be improved.

In addition, as the inductance is improved, harmonic components included in the electric current can be reduced, so that a change in the magnetic flux can be reduced, and the occurrence of the eddy current can be further suppressed. Therefore, it becomes possible to further reduce the eddy current loss in a case where the stator coil of the rotating electric machine is used for charging.

In the stator for the rotating electric machine according to a third aspect of the present invention, in the stator for the rotating electric machine according to the first or second aspect of the present invention, the number of poles of the one phase is n, where n is an even number, and in the one phase, n/2 poles in which the first parallel coil is wound in the third turn and later on the inner diameter side of a rightmost slot for every pole are continuously disposed, and n/2 poles in which the second parallel coil is wound in the third turn and later on the inner diameter side of the rightmost slot for every pole are continuously disposed.

According to this configuration, in half of the number of poles n in one phase, the pole in which the first parallel coil is wound in the third turn and later on the inner diameter side of the rightmost slot for every pole continues, and in the remaining half of the poles, the pole in which the second parallel coil is wound in the third turn and later on the inner diameter side of the rightmost slot for every pole continues. With such an arrangement, when the reverse-phase energization is performed, the substantial number of poles of the stator is reduced, and it becomes possible to make the number of poles of the stator and the number of poles of the rotor unmatched. Due to such an unmatched situation of the number of poles, even though the magnetic flux is generated by AC current supplied at the time of charging, no torque is generated in the rotor, so that the torque at the time of charging can be made zero.

In the stator for the rotating electric machine according to a fourth aspect of the present invention, in the stator for the rotating electric machine according to the third aspect of the present invention, in the one phase, the first parallel coil and the second parallel coil are alternately disposed for every two turns in the third turn and later on the inner diameter side of two poles that are not adjacent to each other out of poles located at a boundary between a pole in which the first parallel coil is wound in the third turn and later on the inner diameter side of the rightmost slot for every pole and a pole in which the second parallel coil is wound in the third turn and later on the inner diameter side of the rightmost slot for every pole.

In a case of an arrangement in which in half of the number of poles n in one phase, the pole in which the first parallel coil is wound in the third turn and later on the inner diameter side of the rightmost slot for every pole continues, and in the remaining half of the poles, the pole in which the second parallel coil is wound in the third turn and later on the inner diameter side of the rightmost slot for every pole continues, the coil pitch in the third turn and later is different from the other parts in the boundary portion where the arrangement of the parallel coils is switched. Therefore, a separate member such as a bus bar is needed for connection between the parallel coils across the boundary portion. In this situation, in a case where bus bar connection is needed in each turn of the third turn and later, the structure and arrangement of the bus bars become complicated in order to prevent interference between the bus bars, or an arrangement with a large detour is needed in order to avoid another bus bar. Thus, a problem such as an increase in size of the stator occurs.

To address such a problem, in the present configuration, the first parallel coil and the second parallel coil are alternately disposed for every two turns in the third turn and later on the inner diameter side of the two poles that are not adjacent to each other out of the poles located at the boundary between the pole in which the first parallel coil is wound in the third turn and later on the inner diameter side of the rightmost slot for every pole and the pole in which the second parallel coil is wound in the third turn and later on the inner diameter side of the rightmost slot for every pole. This eliminates the need for the bus bar connection in the turn in which the first parallel coil and the second parallel coil are alternately disposed, and it becomes possible to use the space generated accordingly, as a space for disposing the bus bars used for the upper and lower turns. Therefore, the structure and arrangement of the bus bars can be simplified, and an increase in size of the stator due to the bus bars can also be avoided.

### BRIEF DESCRIPTION OF DRAWINGS

FIG. 1 is a diagram illustrating an example of a winding method, arrangement of coils, and joining by use of a bus bar, in a stator for a two-phase motor according to an embodiment of the present invention;

FIG. 2 is a diagram illustrating a magnetic flux generated at the time of reverse-phase energization of the two-phase motor; and

FIG. 3 is a diagram illustrating a connection state of a coil to an inverter circuit.

### DETAILED DESCRIPTION

Hereinafter, preferred embodiments of a stator of a rotating electric machine according to the present invention will be described with reference to the drawings. In the present embodiment, an example of using a two-phase motor as a rotating electric machine will be described. A two-phase motor 1 is mounted on, for example, an electric vehicle, and is used as an electric motor for actuating wheels and as a generator for generating electric power by using dynamic power of the wheels.

### Outline of Two-Phase Motor 1

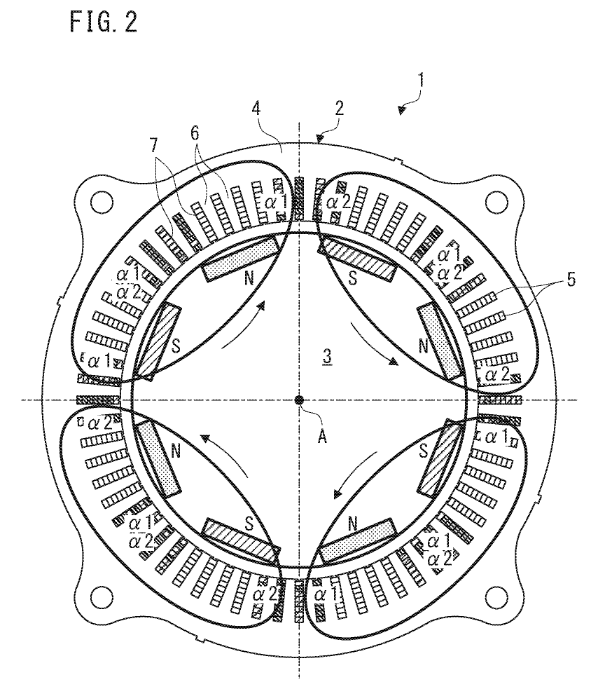

As illustrated in FIG. 2, a two-phase motor 1 includes a stator 2 and a rotor 3. The stator 2 includes a stator core 4 and a coil 5. The rotor 3 includes eight permanent magnets disposed so that the magnetic poles are alternately reversed.

The stator core 4 is a cylindrical member, and a large number of teeth 6 and slots 7 are disposed inside the stator core 4 to be aligned in a circumferential direction. The teeth 6 are parts each extending in a radial direction toward a rotation axis A of the rotor 3 in the stator core 4, and the shape and dimension of a cross-section orthogonal to the rotation axis A are constant regardless of the position in an axial direction. The slot 7 denotes a space defined between two adjacent teeth 6, and thus extends in the radial direction toward the rotation axis A similarly to the teeth 6, and in addition, the shape and dimension of the cross-section orthogonal to the rotation axis A are constant regardless of the position in the axial direction.

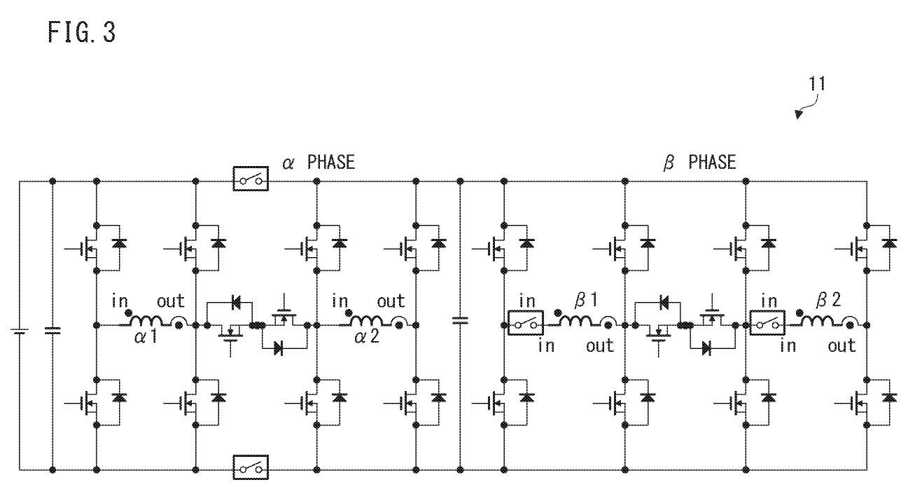

The coil 5 is a conductive wire wound around the teeth 6. Specifically, the coil 5 is wound in the entirety of the stator core 4 by repeating a structure in which end portions of an alphabetical letter U-shaped rectangular wire inserted into two slots 7 are electrically joined to end portions of its adjacent and another letter U-shaped rectangular wire. The coil 5 forms open winding, both ends of which are connected with and incorporated in an inverter circuit 11 (see FIG. 3). With this configuration, in a case where the two-phase motor 1 is used as an electric motor, the coil 5 generates magnetic force for rotating the rotor 3 around the rotation axis A in accordance with energization by the inverter circuit 11, and in a case where the two-phase motor 1 is used as a generator, the coil 5 generates electric current for generating the electric power in accordance with rotation of the rotor 3 and a change in a peripheral magnetic field.

### Configuration of Coil 5

The coil 5 includes a plurality of parallel coils for every phase. According to the present embodiment, the two-phase motor 1 has an α phase and a β phase, and one pole of each phase includes four slots 7. The two-phase motor 1 includes: an α1 coil (a first parallel coil) and an α2 coil (a second parallel coil), which are parallel to each other, and which constitute an α phase; and a β1 coil and a β2 coil, which are parallel to each other, and which constitute a β phase.

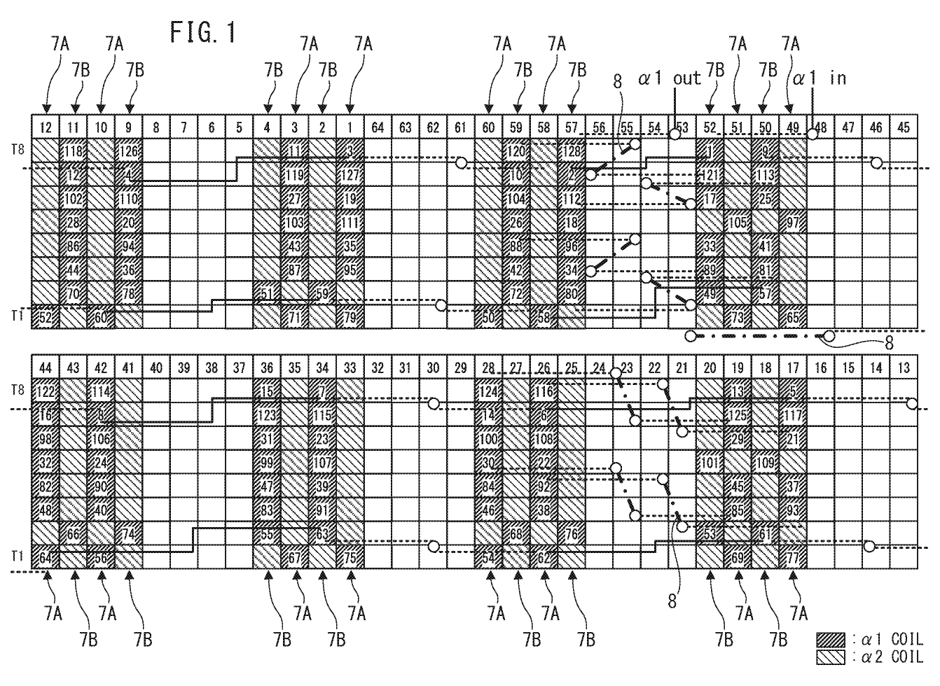

FIG. 1 illustrates an exemplary winding method of the coil 5 and joining by use of a bus bar 8. In the drawing, only the coils of the α phase are specifically illustrated for the sake of simplicity, and an example of winding the α1 coil and joining by use of the bus bar 8 will be mainly described.

Each square in the first row from the top in FIG. 1 indicates a slot number allocated to each slot 7 of the stator core 4, for the sake of convenience. As illustrated in the first row from the top in FIG. 1, 64 slots 7 from 1 to 64 are formed in the stator core 4. Each square in the second to ninth rows from the top in FIG. 1 indicates a position in which one of the end portions of the letter U-shaped rectangular wire that constitutes the coil 5 is inserted into each slot 7. The position numbers written in these squares respectively indicate the sequential order in which the rectangular wire that constitutes the coil of each phase (the α1 coil in FIG. 1) passes.

As illustrated in FIG. 1, a square hatched with dark oblique lines indicates a position into which the rectangular wire that constitutes the α1 coil is inserted, and a square hatched with light oblique lines indicates a position into which the rectangular wire that constitutes the α2 coil is inserted. The rectangular wires that constitute the β1 coil and the β2 coil are inserted into four slots adjacent to the four slots that constitute one pole of the α phase in the same order as the α1 coil and the α2 coil or in a different order, but its illustration is omitted in the present drawing.

The ninth to second rows from the top in FIG. 1 respectively indicate the first turn (T1) to the eighth turn (T8) from an inner diameter side toward an outer diameter side of the stator core 4. The term “turn” used herein refers to each of 64 squares located at a certain distance from the inner diameter side of the stator core 4 in the radial direction of a circle using a point on the rotation axis A as the center and located on a plane orthogonal to the rotation axis A.

In addition, a solid line illustrated in FIG. 1 indicates that a curved part of the letter U-shaped rectangular wire protrudes in a direction from the depth to the front on the sheet surface of FIG. 1. On the other hand, a dotted line illustrated in FIG. 1 indicates that the end portion of the letter U-shaped rectangular wire protrudes in a direction from the front to the depth on the sheet surface of FIG. 1. A dash-dot line in FIG. 1 indicates the bus bar 8, which electrically joins the end portions of the rectangular wires together. A white circle in FIG. 1 indicates a part in which the end portions or the like of the rectangular wires are welded together to be electrically joined together. Hereinafter, the winding method of the α1 coil and joining by use of the bus bar 8 will be specifically described with reference to FIG. 1.

As illustrated in FIG. 1, an end portion α1 in at the winding start of the α1 coil is electrically joined to an end portion of the rectangular wire inserted into the eighth turn, which is the outermost diameter turn of slot number 52, in the vicinity of the position of the eighth turn of slot number 48.

The α1 coil includes a rectangular wire in which one end portion disposed on the right side in FIG. 1 is inserted into the position of the position number 1 of the eighth turn and the other end portion disposed on the left side in FIG. 1 is inserted into the position of the position number 2 of the seventh turn. The α1 coil includes a rectangular wire in which one end portion disposed on the right side in FIG. 1 is inserted into the position of the position number 3 of the eighth turn, and is also electrically joined to the end portion of the rectangular wire inserted into the position of the position number 2, and the other end portion disposed on the left side in FIG. 1 is inserted into the position of the position number 4 of the seventh turn.

The α1 coil includes a rectangular wire in which one end portion disposed on the right side in FIG. 1 is inserted into the position of the position number 5 of the eighth turn, and is also electrically joined to the end portion of the rectangular wire inserted into the position of the position number 4, and the other end portion disposed on the left side in FIG. 1 is inserted into the position of the position number 6 of the seventh turn. The α1 coil includes a rectangular wire in which one end portion disposed on the right side in FIG. 1 is inserted into the position of the position number 7 of the eighth turn, and is also electrically joined to the end portion of the rectangular wire inserted into the position of the position number 6, and the other end portion disposed on the left side in FIG. 1 is inserted into the position of the position number 8 of the seventh turn.

As described heretofore, the α1 coil includes four rectangular wires wound in the position numbers 1 to 8 of the eighth turn and the seventh turn of the slot 7. In addition, although not illustrated, the α1 coil further includes four rectangular wires wound in the position numbers 9 to 16 of the eighth turn and the seventh turn of the slot 7.

The α1 coil further includes, in a similar configuration, a plurality of rectangular wires wound in the direction from the right to the left in FIG. 1 from the sixth turn to the first turn of an innermost diameter of the slot 7, and the end portion of the last rectangular wire is inserted into the position of the position number 64, which corresponds to the first turn of the slot number 44. As described heretofore, the α1 coil is wound in the direction from the right to the left in FIG. 1 from the winding start position to the position of the position number 64 (hereinafter, this part will be referred to as a “forward winding portion”).

In addition, as will be described later, the α1 coil is wound in the direction from the left to the right in FIG. 1 from the position of the position number 65 of the first turn of the slot number 49, which is shifted to the left by five from the position number 64, to the winding end position of the eighth turn (hereinafter, this part will be referred to as a “reverse winding portion”).

The bus bar 8 is used to electrically connect the rectangular wires in a part where the distance between the rectangular wires adjacent to each other becomes irregular due to a change in the winding method of the coil 5. The bus bar 8 electrically connects, for example, an end point of the forward winding portion with a start point of the reverse winding portion of the α1 coil. Specifically, the bus bar 8 is electrically joined to the end portion of the rectangular wire inserted into the position of the position number 64 of the first turn of the slot number 44 and the end portion of the rectangular wire inserted into the position of the position number 65 of the first turn of the slot number 49. Other parts where the bus bar 8 is used will be described later. Note that the bus bar 8 is indicated by the dash-dot line in FIG. 1.

Subsequently, a winding method in the reverse winding portion of the α1 coil will be described. The α1 coil includes a rectangular wire in which an end portion disposed on the left side in FIG. 1 is inserted into the position of the position number 65 of the first turn and an end portion disposed on the right side in FIG. 1 is inserted into the position of the position number 66 of the second turn. The α1 coil includes a rectangular wire in which an end portion disposed on the left side in FIG. 1 is inserted into the position of the position number 67 of the first turn, and is electrically joined to the end portion of the rectangular wire inserted into the position of the position number 66, and an end portion disposed on the right side in FIG. 1 is inserted into the position of the position number 68 of the second turn.

The α1 coil includes a rectangular wire in which an end portion disposed on the left side in FIG. 1 is inserted into the position of the position number 69 of the first turn, and is electrically joined to the end portion of the rectangular wire inserted into the position of the position number 68, and an end portion disposed on the right side in FIG. 1 is inserted into the position of the position number 70 of the second turn. The α1 coil includes a rectangular wire in which an end portion disposed on the left side in FIG. 1 is inserted into the position of the position number 71 of the first turn, and is electrically joined to the end portion of the rectangular wire inserted into the position of the position number 70, and an end portion disposed on the right side in FIG. 1 is inserted into the position of the position number 72 of the second turn.

As described heretofore, the α1 coil includes four rectangular wires wound in the position numbers 65 to 72 of the first turn and the second turn of the slot 7. In addition, the α1 coil further includes four rectangular wires wound in position numbers 73 to 80 of the first turn and the second turn of the slot 7 in a similar manner.

The α1 coil further includes, in a similar configuration, a plurality of rectangular wires wound in the direction from the left to the right in FIG. 1 from the third turn to the eighth turn of the outermost diameter of the slot 7, and an end portion of the last rectangular wire is inserted into the position of the position number 128, which corresponds to the eighth turn of the slot number 57.

As illustrated in FIG. 1, an end portion α1 out at the winding end of the α1 coil is electrically joined to the end portion of the last rectangular wire inserted into the position of the position number 128 in the vicinity of the position of the eighth turn of the slot number 53.

The α2 coil is wound in a similar manner to the α1 coil, and a specific winding method of the α2 coil is as follows. As described above, the position of the slot 7 in which the α2 coil is wound is indicated by a square hatched with the light oblique lines in FIG. 1. The end portion of the rectangular wire at the winding start of the α2 coil is inserted into a predetermined position of the eighth turn of the outermost diameter of the slot 7, and the α2 coil is wound from this position as a start point to a predetermined position of the first turn of the innermost diameter of the slot 7 in the direction from the right to the left in FIG. 1 in a similar winding method to the α1 coil (the forward winding portion). In addition, the winding direction of the α2 coil is reversed using a bus bar (not illustrated) similarly to the α1 coil, and the α2 coil is wound to a predetermined position of the eighth turn of the outermost diameter of the slot 7 in the direction from left to right in FIG. 1 (the reverse winding portion).

Note that as described above, the β1 coil and the β2 coil are wound to pass through white squares located between the respective poles of the α phase. The order of the squares through which the rectangular wires that constitute the β1 coil and the β2 coil pass may be the same as or different from the order of those of the α1 coil and the α2 coil.

### Arrangement of Parallel Coils and The Effects

As described heretofore, the two-phase motor 1 in the present embodiment includes the α phase and the β phase, and the α1 coil and the α2 coil, which constitute the α phase, and which are parallel to each other, are wound in the slot 7 in the arrangement (distribution) illustrated in FIG. 1. Hereinafter, the characteristic arrangement of the parallel coils in the present embodiment and the effects will be described. Note that the two-phase motor 1 in the present embodiment has a characteristic in the arrangement of the α-phase parallel coils (the α1 coil and the α2 coil). However, this is merely an example, and it is possible to configure the parallel coils of β-phase to have a similar arrangement, and it is also possible to configure all parallel coils of α-phase and β-phase to have a similar arrangement.

First, as illustrated in FIG. 1, one pole of one phase (α phase or β phase) of the coil 5 is constituted of four slots 7 (for example, the slot numbers 49 to 52 or the slot numbers 53 to 56), and four slots 7 which constitute the α-phase pole, and four slots 7 which constitute β-phase pole, are alternately disposed in the circumferential direction over the entirety of the stator 2.

Each slot 7 in which the α1 coil and the α2 coil of α phase are wound is classified into a slot 7 in which the α1 coil is wound in the first turn of the innermost diameter and the α2 coil is wound in the second turn (hereinafter, referred to as a “first slot 7A” as appropriate) and a slot 7 in which the α2 coil is wound in the first turn and the α1 coil is wound in the second turn (hereinafter, referred to as a “second slot 7B” as appropriate).

As illustrated in FIG. 1, the first slot 7A and the second slot 7B are alternately disposed in the circumferential direction for every pole. That is, four slots 7 which constitute an α-phase pole are disposed sequentially from the right in the order of the first slot 7A, the second slot 7B, the first slot 7A, and the second slot 7B, or are disposed sequentially from the right in the order of the second slot 7B, the first slot 7A, the second slot 7B, and the first slot 7A.

With such an arrangement of the first slots 7A and the second slots 7B, in the slot 7 which constitutes every pole of the α phase, parallel coils different from each other are wound in the first turn and the second turn of each slot 7, and in addition, parallel coils different from each other are wound in the same first and second turns of adjacent slots 7 for every pole.

Thus, when the two-phase motor 1 is subjected to the reversed-phase energization in which the directions of the electric currents flowing through the first parallel coil and the second parallel coil (the α1 coil and the α2 coil in the α phase and the β1 coil and the β2 coil in the β phase) in one phase are reversed from each other, the magnetic fluxes cancel each other between the first turn and the second turn of the slot 7 which constitutes the α phase, so that an occurrence of the eddy current can be suppressed. Therefore, for example, in a case where the coil 5 of the two-phase motor 1 in the present embodiment mounted on an electric vehicle is used as a part of a charging circuit at the time of charging an in-vehicle high-voltage battery from an external charging device, it becomes possible to reduce an eddy current loss and improve charging efficiency.

In addition, in the two-phase motor 1 in the present embodiment, the first slot 7A is configured such that one of the α1 coil and the α2 coil is mainly wound in the third turn and later for every pole, and the second slot 7B is configured such that the other one of the α1 coil and the α2 coil is mainly wound in the third turn and later for every pole.

That is, the first slot 7A is configured such that, for example, only the α1 coil is wound in the third to eighth turns like the slot numbers 1 and 3, for example, only the α2 coil is wound in the third to eighth turns like the slot numbers 10 and 12, for example, the α2 coil is wound in one of the fifth to sixth turns and the α1 coil is wound in the other third to eighth turns like the slot numbers 17 and 19, or, for example, the α1 coil is wound in one of the fifth to sixth turns and the α2 coil is wound in the other third to eighth turns like the slot numbers 49 and 51.

In addition, the second slot 7B is configured such that, for example, only the α2 coil is wound in the third to eighth turns like the slot numbers 2 and 4, for example, only the α1 coil is wound in the third to eighth turns like the slot numbers 9 and 11, for example, the α1 coil is wound in one of the fifth to sixth turns and the α2 coil is wound in the other third to eighth turns like the slot numbers 18 and 20, or, for example, the α2 coil is wound in one of the fifth to sixth turns and the α1 coil is wound in the other third to eighth turns like the slot numbers 50 and 52.

As described above, the first slot 7A and the second slot 7B are alternately disposed in the circumferential direction for every pole. Thus, in the α-phase of the two-phase motor 1 in the present embodiment, the α1 coil and the α2 coil are alternately disposed to be aligned in the circumferential direction in the third turn and later in each slot 7 for every pole. Thus, when the reverse-phase energization is performed on the two-phase motor 1, interference between the magnetic flux generated in the α1 coil and the magnetic flux generated in the α2 coil can be suppressed as illustrated in FIG. 2, so that the inductance can be improved. By improving the inductance, the quality of the electric current at the time of charging can be improved, and the charging efficiency can be improved.

In addition, as the inductance is improved, harmonic components included in the electric current can be reduced, so that a change in the magnetic flux can be reduced. Therefore, the occurrence of the eddy current can be further suppressed. Thus, in a case where the coil 5 of the two-phase motor 1 is used as a part of the charging circuit, it becomes possible to further reduce the eddy current loss, so that the charging efficiency can be improved.

Further, in the two-phase motor 1 in the present embodiment, the number of poles of one phase is n (where n is an even number). In the α phase, n/2 poles in which the α1 coil is mainly wound in the third turn and later of the rightmost slot 7 for every pole are continuously disposed, and in addition, n/2 poles in which the α2 coil is mainly wound in the third turn and later of the rightmost slot 7 for every pole are continuously disposed.

That is, in the two-phase motor 1 in the present embodiment, there are eight poles in one phase. In the α phase, in four poles corresponding to a half the number of poles, the pole in which the first parallel coil is mainly wound in the third turn and later on the inner diameter side of the rightmost slot 7 for every pole continues (in the example of FIG. 1, the pole including slot numbers 57, 1, 9, and 17). In addition, in the remaining four poles, the pole in which the second parallel coil is mainly wound in the third turn and later on the inner diameter side of the rightmost slot 7 for every pole continues (in the example of FIG. 1, the pole including slot numbers 25, 33, 41, and 49).

With such an arrangement, when the reverse-phase energization is performed on the two-phase motor 1, two magnetic fluxes that pass through the first slot 7A of the α1 coil and two magnetic fluxes that pass through the first slot 7A of the α2 coil are generated as illustrated in FIG. 2, the stator 2 corresponds to four poles, and the substantial number of poles decreases. On the other hand, since the rotor 3 includes eight poles as described above, it becomes possible to make the number of poles of the stator 2 and the number of poles of the rotor 3 unmatched. Due to such an unmatched situation of the number of poles, even though the magnetic flux is generated by AC current supplied at the time of charging, no torque is generated in the rotor 3, so that the torque at the time of charging can be made zero.

In addition, in the two-phase motor 1 in the present embodiment, the α1 coil and the α2 coil are alternately disposed for every two turns in the third turn and later in two poles that are not adjacent to each other among the poles located at the boundary between the pole in which the α1 coil is mainly wound in the third turn and later of the rightmost slot 7 for every pole and the pole in which the α2 coil is mainly wound in the third turn and later of the rightmost slot 7 for every pole.

In the example of FIG. 1, the poles located at the boundary between the pole in which the α1 coil is mainly wound in the third turn and later of the rightmost slot 7 for every pole and the pole in which the α2 coil is mainly wound in the third turn and later of the rightmost slot 7 for every pole denote four poles which are the pole including the slot number 57 and the pole including the slot number 49, and the pole including the slot number 17 and the pole including the slot number 25 (hereinafter, these four poles will be referred to as four poles in boundary portions for the sake of convenience). In the present embodiment, in the pole including the slot number 49 and the pole including the slot number 17 that are two poles not adjacent to each other among the four poles in the boundary portion, the α1 coil and the α2 coil are alternately disposed for every two turns in the third turn and later, that is, the fifth to sixth turns.

In the four poles in the boundary portions, a change in the winding method of the coil 5 changes the distance between the rectangular wires joined to be adjacent to each other. For example, in the example of FIG. 1, in the poles other than the four poles in the boundary portions, the distance between the rectangular wires joined to be adjacent to each other corresponds to eight squares, whereas in the four poles in the boundary portions, the distance corresponds to, for example, seven squares or nine squares. For this reason, it is not possible to join the rectangular wires together as they are, and thus electric connection is established through the bus bar 8. In this situation, in a case where bus bar connection is needed in each turn of the third turn and later, the structure and arrangement of the bus bars become complicated in order to prevent interference between the bus bars 8. Thus, a problem such as an increase in size of the stator 2 may occur in some cases.

On the other hand, in the present embodiment, since the α1 coil and the α2 coil are alternately disposed in the fifth to sixth turns in the two poles (in the example of FIG. 1, the pole including the slot number 49 and the pole including the slot number 17) that are not adjacent to each other among the four poles in the boundary portions, the bus bar connection can be made unnecessary for such turns. Therefore, it becomes possible to use the space generated accordingly as a space for disposing the bus bars 8 to be used for the upper and lower turns (the third to fourth turns and the seventh and eighth turns). Accordingly, the structure and arrangement of the bus bars 8 can be simplified, and an increase in size of the stator 2 due to the bus bars 8 can also be avoided.

Note that in the above-described embodiments, the case where the rotating electric machine according to an embodiment is a two-phase motor has been described as an example. However, without being limited to this, for example, a three-phase motor may be applicable. Additionally, the present invention is not limited to the above-described embodiments. That is, the present invention includes embodiments subjected to various modifications, substitutions, design changes, and the like based on the gist of the present invention, and does not exclude these embodiments.

What is claimed is:

1. A stator for a rotating electric machine, the stator comprising:
a stator core including a plurality of slots, each of which extends in a radial direction, and which are aligned in a circumferential direction; and
a coil, which includes a plurality of parallel coils for every phase, and which is wound in the circumferential direction to pass through a plurality of turns in the plurality of slots, wherein
the coil includes a first parallel coil and a second parallel coil that are parallel to each other in at least one phase,
the slot includes a first slot in which the first parallel coil is wound in a first turn on an inner diameter side and the second parallel coil is wound in a second turn on the inner diameter side, and a second slot in which the second parallel coil is wound in the first turn on the inner diameter side and the first parallel coil is wound in the second turn on the inner diameter side, and
the first slot and the second slot are alternately disposed in the circumferential direction for every pole.

2. The stator for the rotating electric machine according to claim 1, wherein
in the first slot, one of the first parallel coil and the second parallel coil is wound in a third turn and later on the inner diameter side for every pole, and
in the second slot, the other one of the first parallel coil and the second parallel coil is wound in the third turn and later on the inner diameter side for every pole.

3. The stator for the rotating electric machine according to claim 1, wherein
the number of poles of the one phase is n, where n is an even number, and
in the one phase, n/2 poles in which the first parallel coil is wound in the third turn and later on the inner diameter side of a rightmost slot for every pole are continuously disposed, and n/2 poles in which the second parallel coil is wound in the third turn and later on the inner diameter side of the rightmost slot for every pole are continuously disposed.

4. The stator for the rotating electric machine according to claim 3, wherein
in the one phase, the first parallel coil and the second parallel coil are alternately disposed for every two turns in the third turn and later on the inner diameter side of two poles that are not adjacent to each other out of poles located at a boundary between a pole in which the first parallel coil is wound in the third turn and later on the inner diameter side of the rightmost slot for every pole and a pole in which the second parallel coil is wound in the third turn and later on the inner diameter side of the rightmost slot for every pole.
